(19) United States
(12) Patent Application Publication
(10) Pub. No.: US 2024/0386672 A1
(43) Pub. Date: Nov. 21, 2024

(54) METHODS AND SYSTEMS FOR THREE-DIMENSIONAL VISUALIZATION

(71) Applicant: Epicor Software Corporation, Austin, TX (US)

(72) Inventor: Raymon Andrew Ohmori, East Amherst, NY (US)

(21) Appl. No.: 18/587,143

(22) Filed: Feb. 26, 2024

Related U.S. Application Data
(60) Provisional application No. 63/502,267, filed on May 15, 2023.

(51) Int. Cl. G06T 17/10; G06T 11/20; G06T 15/04; G06T 15/50; G06T 17/20; G06T 19/20

(52) U.S. Cl. CPC G06T 17/10; G06T 11/203; G06T 15/04; G06T 15/50; G06T 17/20; G06T 19/20; G06T 2200/24

(57) ABSTRACT

Embodiments of the disclosure provide systems and methods for generating a three-dimensional drawing or representation of a product or other object. According to one embodiment, a method for generating a three-dimensional drawing representing an object can comprise presenting a two-dimensional sketching user interface and receiving two-dimensional sketch data through the two-dimensional sketch user interface. The two-dimensional sketch data can define a plurality of nodes and the plurality of nodes can define a two-dimensional sketch of at least a portion of the object. Node data for each of the plurality of nodes defined in the two-dimensional sketch data can be read and the three-dimensional drawing representing the object can be extruded from the node data.

### CROSS REFERENCE TO RELATED APPLICATION

The present application claims the benefits of and priority, under 35 U.S.C. § 119 (e), to U.S. Provisional Application No. 63/502,267 filed May 15, 2023 by Ohmori and entitled “Methods and Systems for Three-Dimensional Visualization in E-Commerce Solutions” of which the entire disclosure is incorporated herein by reference for all purposes.

### FIELD OF THE DISCLOSURE

Embodiments of the present disclosure relate generally to methods and systems for generating electronic representation of physical objects and more particularly to generating a three-dimensional drawing or representation of a product or other object.

### BACKGROUND

Configure, Price, Quote (CPQ) refers to processes and systems through which businesses can design and specify customized products. Within CPQ technology, visualization is an important component that allows users to see what they have configured. As the industry and buyer behaviors evolve, companies are challenged with providing high quality visualization (photorealism) with rapid response time to changes made when building a configuration in an ecommerce website or application for example. Hence, there is a need for improved methods and systems for generating a three-dimensional drawing or representation of a product or other object.

### BRIEF SUMMARY

Embodiments of the disclosure provide systems and methods for generating a three-dimensional drawing or representation of a product or other object. According to one embodiment, a method for generating a three-dimensional drawing representing an object can comprise presenting a two-dimensional sketching user interface and receiving two-dimensional sketch data through the two-dimensional sketch user interface. Receiving the two-dimensional sketch data can comprise receiving a user input through the two-dimensional sketching user interface. Additionally, or alternatively, receiving the two-dimensional sketch data comprises receiving an indication of an image file through the two-dimensional sketching user interface and reading the indicated image file.

The two-dimensional sketch data can define a plurality of nodes and the plurality of nodes can define a two-dimensional sketch of at least a portion of the object. Node data for each of the plurality of nodes defined in the two-dimensional sketch data can be read and the three-dimensional drawing representing the object can be extruded from the node data. The plurality of nodes can comprise a mesh node, the mesh node defining one or more of position, rotation, or scaling for the node. Additionally, or alternatively, the plurality of nodes can comprise a mesh feature node, the mesh feature node providing for manipulation of one or more features of the node. The plurality of nodes cam additionally, or alternatively, comprise a connector node, the connector node comprising a position property and a direction property defining point on a mesh for use by other nodes. In some cases, the plurality of nodes can additionally, or alternatively, comprise a texture layer node, the texture layer node comprising a path to an image and properties to scale, blend, or colorize the image to other nodes. In such cases, the plurality of nodes can comprise a material node, the material node comprising a plurality of ordered texture nodes. Additionally, or alternatively, the plurality of nodes can comprise a light node, the light node defining properties affecting light or color on a surface of the three-dimensional drawing. The plurality of nodes can additionally, or alternatively, comprise a mate node, the mate node comprising properties to link a plurality of other nodes. Additionally, or alternatively, the plurality of nodes can comprise an annotation and dimension node, the annotation and dimension node comprising text and properties to attach to connector nodes.

In some case, the method can further comprise receiving manipulation of the two-dimensional sketch data through the two-dimensional sketching user interface. The received manipulations of the two-dimensional sketch data can be tracked and the three-dimensional drawing can be updated based on the tracking of the received manipulations of the two-dimensional sketch data.

According to another embodiment, a system can comprise a processor and a memory coupled with and readable by the processor. The memory can store therein a set of instructions which, when executed by the processor, causes the processor to generate a three-dimensional drawing representing of an object by presenting a two-dimensional sketching user interface and receiving two-dimensional sketch data through the two-dimensional sketch user interface. The two-dimensional sketch data can define a plurality of nodes and the plurality of nodes can define a two-dimensional sketch of at least a portion of the object. Receiving the two-dimensional sketch data can comprise receiving a user input through the two-dimensional sketching user interface. Additionally, or alternatively, receiving the two-dimensional sketch data can comprise receiving an indication of an image file through the two-dimensional sketching user interface and reading the indicated image file.

The instructions can further cause the processor to read node data for each of the plurality of nodes defined in the two-dimensional sketch data and extrude the three-dimensional drawing representing the object from the node data. In some cases, the instructions can further cause the processor to receive manipulation of the two-dimensional sketch data through the two-dimensional sketching user interface, track the received manipulations of the two-dimensional sketch data, and update the three-dimensional drawing based on the tracking of the received manipulations of the two-dimensional sketch data.

According to yet another embodiment, a non-transitory, computer-readable medium can comprise a set of instructions stored therein which, when executed by a processor, causes the processor to generate a three-dimensional drawing representing of an object by presenting a two-dimensional sketching user interface and receiving two-dimensional sketch data through the two-dimensional sketch user interface. The two-dimensional sketch data can define a plurality of nodes and the plurality of nodes can define a two-dimensional sketch of at least a portion of the object. Receiving the two-dimensional sketch data can comprise receiving a user input through the two-dimensional sketching user interface. Additionally, or alternatively, receiving the two-dimensional sketch data can comprise receiving an indication of an image file through the two-dimensional sketching user interface and reading the indicated image file.

The instructions can further cause the processor to read node data for each of the plurality of nodes defined in the two-dimensional sketch data and extrude the three-dimensional drawing representing the object from the node data. In some cases, the instructions can further cause the processor to receive manipulation of the two-dimensional sketch data through the two-dimensional sketching user interface, track the received manipulations of the two-dimensional sketch data, and update the three-dimensional drawing based on the tracking of the received manipulations of the two-dimensional sketch data.

### BRIEF DESCRIPTION OF THE DRAWINGS

FIG. 1 is a block diagram illustrating elements of an exemplary computing environment in which embodiments of the present disclosure may be implemented.

FIG. 2 is a block diagram illustrating elements of an exemplary computing device in which embodiments of the present disclosure may be implemented.

FIG. 3 is a block diagram illustrating an exemplary in which three-dimensional visualization may be provided according to embodiments of the present disclosure.

FIG. 4 illustrates an exemplary user-submitted drawing from which a three-dimensional visualization can be generated using embodiments of the present disclosure.

FIG. 5 illustrates an exemplary three-dimensional visualization as may be generated using embodiments of the present disclosure.

FIG. 6 is a flowchart illustrating an exemplary process for generating a three-dimensional visualization according to embodiments of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the ensuing description omits a number of known structures and devices. This omission is not to be construed as a limitation of the scopes of the claims. Rather, the ensuing description of the exemplary embodiments will provide those skilled in the art with an enabling description for implementing an exemplary embodiment. It should, however, be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire or fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programmable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an Application-Specific Integrated Circuit (ASIC) or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

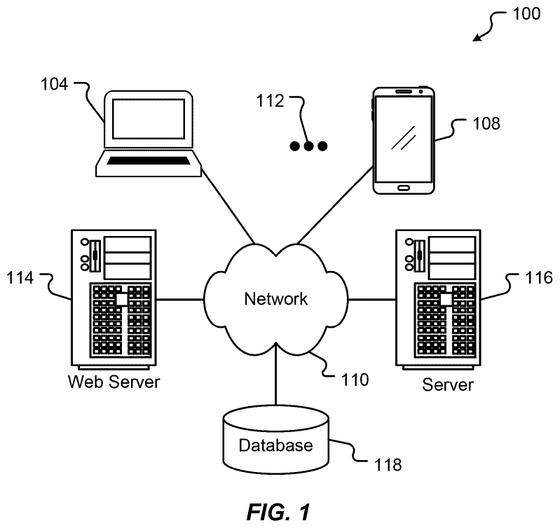

FIG. 1 is a block diagram illustrating elements of an exemplary computing environment in which embodiments of the present disclosure may be implemented. More specifically, this example illustrates a computing environment 100 that may function as the servers, user computers, or other systems provided and described herein. The environment 100 includes one or more user computers, or computing devices, such as a computing device 104, a communication device 108, and/or more 112. The computing devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 104, 108, 112 may also have any of a variety of applications, including for example, database client and/or server applications, and web browser applications. Alternatively, the computing devices 104, 108, 112 may be any other electronic device, such as a thin-client computer, Internet-enabled mobile telephone, and/or personal digital assistant, capable of communicating via a network 110 and/or displaying and navigating web pages or other types of electronic documents. Although the exemplary computer environment 100 is shown with two computing devices, any number of user computers or computing devices may be supported.

Environment 100 further includes a network 110. The network 110 may be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 may be a LAN, such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 114, 116. In this example, server 114 is shown as a web server and server 116 is shown as an application server. The web server 114 may be used to process requests for web pages or other electronic documents from computing devices 104, 108, 112. The web server 114 can be running an operating system including any of those discussed above, as well as any commercially-available server operating systems. The web server 114 can also run a variety of server applications, including SIP servers, HyperText Transfer Protocol (secure) (HTTP(s)) servers, FTP servers, CGI servers, database servers, Java servers, and the like. In some instances, the web server 114 may publish operations or available operations as one or more web services.

The environment 100 may also include one or more file and or/application servers 116, which can, in addition to an operating system, include one or more applications accessible by a client running on one or more of the computing devices 104, 108, 112. The server(s) 116 and/or 114 may be one or more general purpose computers capable of executing programs or scripts in response to the computing devices 104, 108, 112. As one example, the server 116, 114 may execute one or more web applications. The web application may be implemented as one or more scripts or programs written in any programming language, such as Java™, C, C#®, or C++, and/or any scripting language, such as Perl, Python, or Tool Command Language (TCL), as well as combinations of any programming/scripting languages. The application server(s) 116 may also include database servers, including without limitation those commercially available from Oracle®, Microsoft®, Sybase®, IBM® and the like, which can process requests from database clients running on a computing device 104, 108, 112.

The web pages created by the server 114 and/or 116 may be forwarded to a computing device 104, 108, 112 via a web (file) server 114, 116. Similarly, the web server 114 may be able to receive web page requests, web services invocations, and/or input data from a computing device 104, 108, 112 (e.g., a user computer, etc.) and can forward the web page requests and/or input data to the web (application) server 116. In further embodiments, the server 116 may function as a file server. Although for case of description, FIG. 1 illustrates a separate web server 114 and file/application server 116, those skilled in the art will recognize that the functions described with respect to servers 114, 116 may be performed by a single server and/or a plurality of specialized servers, depending on implementation-specific needs and parameters. The computer systems 104, 108, 112, web (file) server 114 and/or web (application) server 116 may function as the system, devices, or components described herein.

The environment 100 may also include a database 118. The database 118 may reside in a variety of locations. By way of example, database 118 may reside on a storage medium local to (and/or resident in) one or more of the computers 104, 108, 112, 114, 116. Alternatively, it may be remote from any or all of the computers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers 104, 108, 112, 114, 116 may be stored locally on the respective computer and/or remotely, as appropriate. The database 118 may be a relational database, such as Oracle 20I®, that is adapted to store, update, and retrieve data in response to Structured Query Language (SQL) formatted commands.

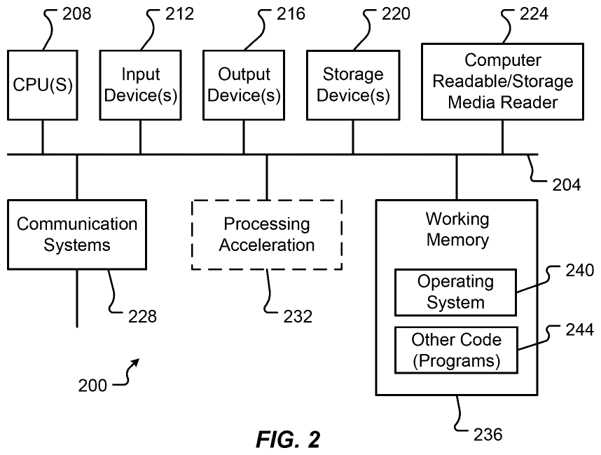

FIG. 2 is a block diagram illustrating elements of an exemplary computing device in which embodiments of the present disclosure may be implemented. More specifically, this example illustrates one embodiment of a computer system 200 upon which the servers, user computers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any one or more servers and/or other computing devices as described above can be adapted, for example, to provide various e-commerce solutions as known in the art. For example, these systems can be adapted to provide a Configure, Price, Quote (CPQ) solution. As known in the art, CPQ is a term used in business to describe software systems that help sellers quote complex and configurable products, create three-dimensional visualizations of the product, configure the product, etc. Embodiments of the present disclosure are directed to enhancements of a CPQ system that allow users to create three-dimensional visualizations of a product. The three-dimensional visualization can be represented by an abstraction that is easily manipulated by a graphical programming language. This, combined with an internal change tracker, allows users with limited technical knowledge to create a high-performance, high-fidelity visualization of their product that runs on a wide range of hardware without having to rely on a third party to create and maintain their three-dimensional visualizations. Generally speaking, and as will be described below, two-dimensional sketching tools accessible to an end-user can be used to generate sketches of products from which a three-dimensional visualization can be extruded.

Within CPQ technology, visualization allows users to see what they have configured. As industry and buyer behaviors evolve, companies are challenged with providing high quality visualization (photorealism) with rapid response time to changes made when building a configuration in an e-commerce website or application for example. Embodiments of the present disclosure allow the customer to create high quality visualizations quickly, often in real-time.

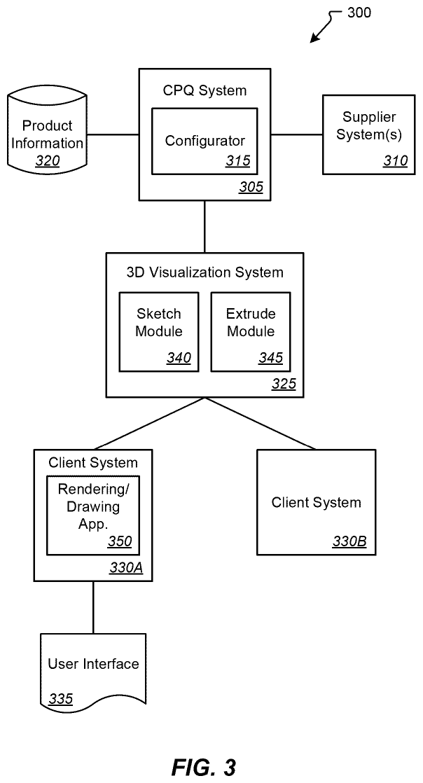

FIG. 3 is a block diagram illustrating an exemplary environment in which three-dimensional visualizations may be provided according to embodiments of the present disclosure. As illustrated in this example, the environment 300 can include a CPG system 305 which can comprise any one or more servers and/or other computing devices as described above. The CPG system 305 can be coupled with one or more supplier system(s) 310 via a communications network (not shown here). The one or more supplier systems 310 can also comprise any one or more servers and/or other computing systems as described above. The communications network (not shown here) can comprise any one or more wired and/or wireless, local-area and/or wide-area networks as described above. The CPG system 305 can execute a configurator 315 which, as known in the art, can allow users of the CPG system 305 to generate product configurations based on information from the supplier system(s) 310 and/or product information 320 maintained by the CPG system 305, the supplier systems 310, and/or other systems.

The environment 300 can also include a three-dimensional visualization system 325. It should be noted that, while illustrated here as separate from the CPG system 305 for the sake of clarity, the three-dimensional visualization system 325 can be implemented on the same or different physical and/or virtual machines as the CPG system 305 depending upon the exact implementation and without departing from the scope of the present disclosure. Generally speaking, the three-dimensional visualization system 325 can present to any number of client systems 330A-330B a user interface 335 through which a user can generate a two-dimensional sketch or drawing of a proposed product. Based on this two-dimensional sketch, the three-dimensional visualization system 325 can generate a three-dimensional visualization of the proposed product to be rendered on user interfaces 335 of the client systems 330A-330B, e.g., webpages, and/or used to generate product configuration information.

As illustrated in this example, the three-dimensional visualization system 325 can include a sketch module 340 and an extrude module 345. The sketch module 340 and extrude module 345 can each comprise software that allows a customer, through a client system 330A executing a rendering/drawing application 350, to define the visualization for their product in terms of a two-dimensional sketch and optionally a path to extrude such a sketch. According to one embodiment, the two-dimensional sketch can comprise a non-parametric vector path defined with control points in the same manner as paths in an Scalable Vector Graphics (SVG) graphic. Because the sketch is non-parametric, i.e., created using interpolation or smoothing techniques to connect the control points, it is much simpler to map values in fields completed by an end-user from the CPG system 305 configurator 315 to the control points in the sketch. This two-dimensional sketch can then be extruded in a linear direction, swept along another path defined by a sketch, or rotated around an axis to create a solid shape.

According to one embodiment, the rendering/drawing application 350 can comprise a web browser implementing ECMAScript and the latest Khronos Group WebGL 2.0 open-source specification. Common browsers such as Google Chrome, Microsoft Edge, Mozilla Firefox, and Safari support these Application Program Interfaces (APIs). The three-dimensional visualization system 325 can use the Babylon open-source project to drive a three-dimensional engine and handle the translation to low-level WebGL shaders.

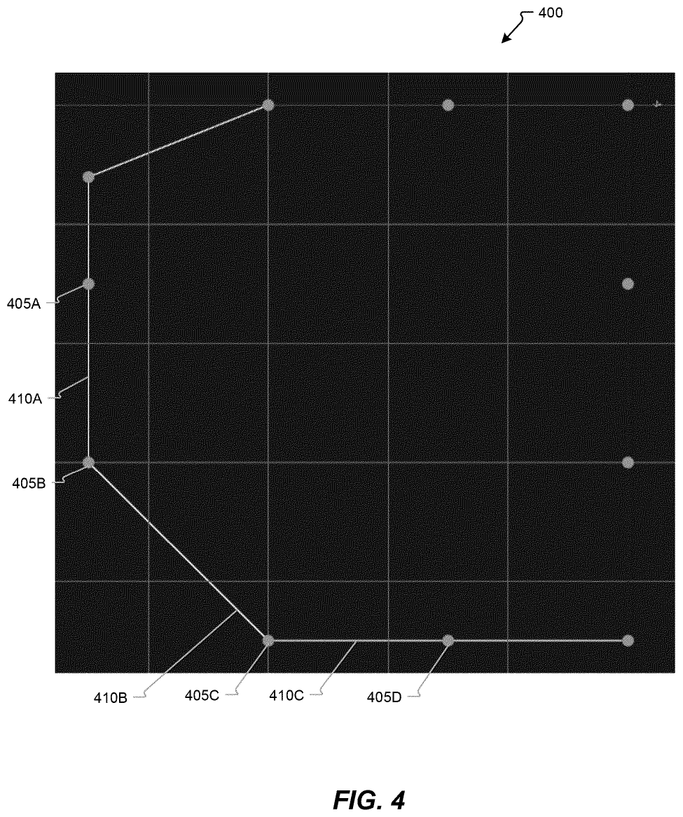

FIG. 4 illustrates an exemplary user-submitted drawing from which a three-dimensional visualization can be generated using embodiments of the present disclosure. This example illustrates a drawing as may be received by the three-dimensional visualization system 325 through a sketch module 340 from a client device executing a rendering/drawing application 350 as introduced above. As illustrated here, the user of the client device can draw out an arbitrary sketch 400 by creating control points 405A-405D. The sketch can consist of straight lines 410A-410C as well as Bezier curves, splines and arcs/circles between the control points 405A-405D.

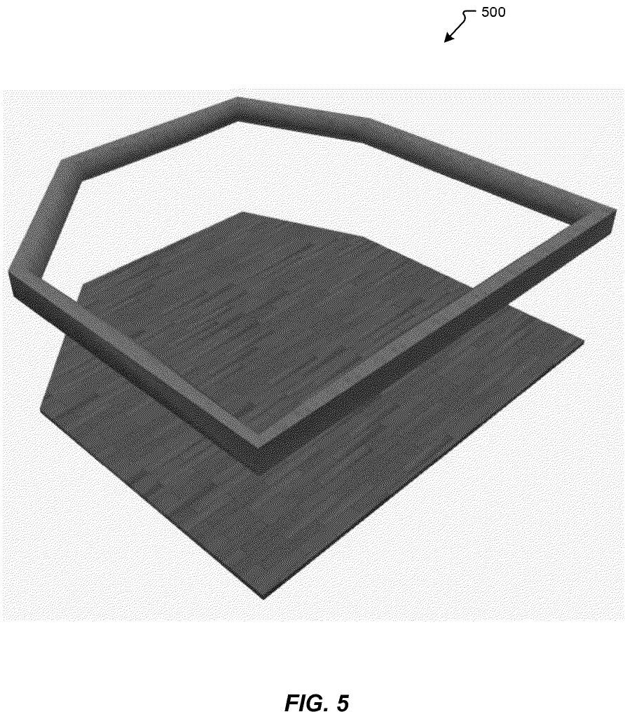

FIG. 5 illustrates an exemplary three-dimensional visualization as may be generated using embodiments of the present disclosure. More specifically, this example illustrates a three-dimensional visualization 500 as may be extruded from the two-dimensional sketch 400 illustrated in FIG. 4. The sketch can be used as a sweep path or a shape to extrude, configured based on the specific configurator's 315 needs.

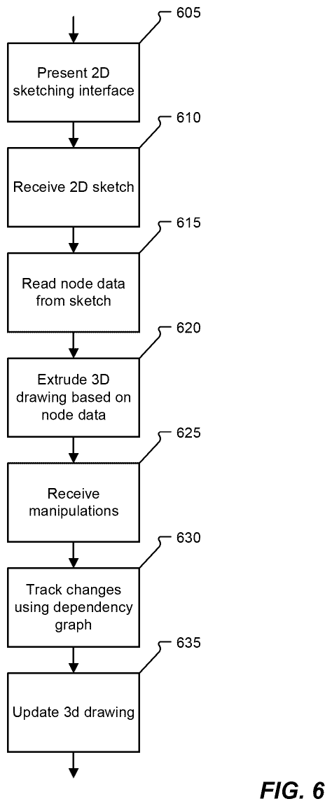

FIG. 6 is a flowchart illustrating an exemplary process for generating a three-dimensional visualization according to embodiments of the present disclosure. Generally speaking, and as illustrated in this example, generating a three-dimensional visualization can begin with presenting 605, through a client system 330A executing a rendering/drawing application 350, a two-dimensional sketching user interface 335 and receiving 610, through this interface 335, a two-dimensional sketch 400. According to one embodiment, a sketch editor in a browser user interface 335 can allow the end-user to easily edit sketches and their constituent parts by dragging and dropping control points and configuring what type of curve each sketch path will have. Additionally, or alternatively, one or more image files such as a Comma Separated Values (CSV), for example, or other image format file can be imported. In some cases, this image can be presented as a two-dimensional image on which the user may further sketch.

Node data of one or more nodes represented in the two-dimensional drawing can be read 615. The three-dimensional visualization system 325 can handle the management of nodes, i.e., logical entities that have properties that can be manipulated translated, e.g., to Babylon and WebGL objects, that can be displayed in a browser. Nodes can include, but are not limited to mesh nodes, i.e., geometry meshes with positions, rotations, and scaling. Additionally, or alternatively, nodes can include mesh feature nodes, which allow manipulation of the meshes via different properties depending on the feature type to transform the geometry, apply UV maps, create patterns from the geometry, etc. The features can be additive so the geometry can be adjusted and then the resulting geometry can be patterned, for example. Nodes can additionally, or alternatively, comprise connector nodes, which are placed on mesh nodes and have a position and direction property to create defined points on a mesh for use by other nodes. Additionally, or alternatively, the nodes can comprise any one or more of: texture layer nodes, which have a path to a rasterized or vector image and have properties to scale, blend or colorize themselves with other layers nodes; material nodes, which accept a collection of ordered texture layer nodes and PBR properties such as color, roughness and metallic; light nodes, which have properties to adjust the position of lights, lighting intensity and color; mate nodes, which have properties to link two mesh nodes together via attached connectors; and/or annotation and dimension nodes, which accept arbitrary text and have properties to attach themselves to connectors.

A three-dimensional drawing can then be extruded 620 from the two-dimensional drawing based on the node data. According to one embodiment, several node types can be used in concert to create any arbitrary mesh programmatically. For example, a control point node type, can consist of a position and two directions. Depending on the path type, the control point directions can affect the shape that the curves will take in the path. A path node type can act as a container for control points. A path can define what type of line or curve will be generated from the control points, so multiple paths are needed if a sketch has different types of curves in it. In another example, a sketch type node can act as a container for the paths defining a complete shape.

Properties on any node including sketch, path and control point nodes can be manipulated at runtime with code to adjust the visualization based on the settings in the configured product. These manipulations can be received 625 and tracked 630 using a dependency graph, for example, and the three-dimensional drawing can be updated 635 accordingly. That is, to prevent having to re-generate all of the three-dimensional geometries and materials with any change, a dependency graph algorithm can be used in a change tracker to only update the portions of the scene that need to be updated with any given change in any given node. Configured sketches can be used as a line drawing, extruded in a straight line, or swept along another sketch path to generate geometry depending on the needs of the configurator 315 visualization. In some cases, sketches can be combined in several ways. For example, one sketch can be the cross-section of geometry, and the other sketch can be the path to sweep the cross-section. In another example, both sketches can be extruded or swept, and then the two geometries can be joined with a union, intersection or subtraction operation.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving case and/or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for generating a three-dimensional drawing representing an object, the method comprising:
presenting, by a processor of a three-dimensional visualization system, a two-dimensional sketching user interface;
receiving, by the processor of the three-dimensional visualization system, two-dimensional sketch data through the two-dimensional sketch user interface, the two-dimensional sketch data defining a plurality of nodes and the plurality of nodes defining a two-dimensional sketch of at least a portion of the object;
reading, by the processor of the three-dimensional visualization system, node data for each of the plurality of nodes defined in the two-dimensional sketch data; and
extruding, by the processor of the three-dimensional visualization system, the three-dimensional drawing representing the object from the node data.

2. The method of claim 1, further comprising:
receiving, by the processor of the three-dimensional visualization system, manipulation of the two-dimensional sketch data through the two-dimensional sketching user interface;
tracking, by the processor of the three-dimensional visualization system, the received manipulations of the two-dimensional sketch data; and
updating, by the processor of the three-dimensional visualization system, the three-dimensional drawing based on the tracking of the received manipulations of the two-dimensional sketch data.

3. The method of claim 1, wherein receiving the two-dimensional sketch data comprises receiving a user input through the two-dimensional sketching user interface.

4. The method of claim 1, wherein receiving the two-dimensional sketch data comprises receiving an indication of an image file through the two-dimensional sketching user interface and reading the indicated image file.

5. The method of claim 1, wherein the plurality of nodes comprise a mesh node, the mesh node defining one or more of position, rotation, or scaling for the node.

6. The method of claim 1, wherein the plurality of nodes comprise a mesh feature node, the mesh feature node providing for manipulation of one or more features of the node.

7. The method of claim 1, wherein the plurality of nodes comprise a connector node, the connector node comprising a position property and a direction property defining point on a mesh for use by other nodes.

8. The method of claim 1, wherein the plurality of nodes comprise a texture layer node, the texture layer node comprising a path to an image and properties to scale, blend, or colorize the image to other nodes.

9. The method of claim 8, wherein the plurality of nodes comprise a material node, the material node comprising a plurality of ordered texture nodes.

10. The method of claim 1, wherein the plurality of nodes comprise a light node, the light node defining properties affecting light or color on a surface of the three-dimensional drawing.

11. The method of claim 1, wherein the plurality of nodes comprise a mate node, the mate node comprising properties to link a plurality of other nodes.

12. The method of claim 1, wherein the plurality of nodes comprise an annotation and dimension node, the annotation and dimension node comprising text and properties to attach to connector nodes.

13. A system comprising:
a processor; and
a memory coupled with and readable by the processor and storing therein a set of instructions which, when executed by the processor, causes the processor to generate a three-dimensional drawing representing an object by:
presenting a two-dimensional sketching user interface;
receiving two-dimensional sketch data through the two-dimensional sketch user interface, the two-dimensional sketch data defining a plurality of nodes and the plurality of nodes defining a two-dimensional sketch of at least a portion of the object;
reading node data for each of the plurality of nodes defined in the two-dimensional sketch data; and
extruding the three-dimensional drawing representing the object from the node data.

14. The system of claim 13, wherein the instructions further cause the processor to:
receive manipulation of the two-dimensional sketch data through the two-dimensional sketching user interface;
track the received manipulations of the two-dimensional sketch data; and
update the three-dimensional drawing based on the tracking of the received manipulations of the two-dimensional sketch data.

15. The system of claim 13, wherein receiving the two-dimensional sketch data comprises receiving a user input through the two-dimensional sketching user interface.

16. The system of claim 13, wherein receiving the two-dimensional sketch data comprises receiving an indication of an image file through the two-dimensional sketching user interface and reading the indicated image file.

17. A non-transitory, computer-readable medium comprising a set of instructions stored therein which, when executed by a processor, causes the processor to generate a three-dimensional drawing representing an object by:
presenting a two-dimensional sketching user interface;
receiving two-dimensional sketch data through the two-dimensional sketch user interface, the two-dimensional sketch data defining a plurality of nodes and the plurality of nodes defining a two-dimensional sketch of at least a portion of the object;
reading node data for each of the plurality of nodes defined in the two-dimensional sketch data; and
extruding the three-dimensional drawing representing the object from the node data.

18. The non-transitory, computer-readable medium of claim 17, wherein the instructions further cause the processor to:
receive manipulation of the two-dimensional sketch data through the two-dimensional sketching user interface;
track the received manipulations of the two-dimensional sketch data; and
update the three-dimensional drawing based on the tracking of the received manipulations of the two-dimensional sketch data.

19. The non-transitory, computer-readable medium of claim 17, wherein receiving the two-dimensional sketch data comprises receiving a user input through the two-dimensional sketching user interface.

20. The non-transitory, computer-readable medium of claim 17, wherein receiving the two-dimensional sketch data comprises receiving an indication of an image file through the two-dimensional sketching user interface and reading the indicated image file.
